(19) United States
(12) Patent Application Publication
(10) Pub. No.: US 2026/0112286 A1
(43) Pub. Date: Apr. 23, 2026

(54) Training Simulator and Operator Training Method Using the Same

(71) Applicant: LG Energy Solution, Ltd., Seoul (KR)

(72) Inventors: Dae Ho Kang, Daejeon (KR); Eung Seo Kim, Daejeon (KR)

(73) Assignee: LG Energy Solution, Ltd., Seoul (KR)

(21) Appl. No.: 19/354,922

(22) Filed: Oct. 10, 2025

(30) Foreign Application Priority Data
Oct. 21, 2024 (KR) 10-2024-0143551

(51) Int. Cl. G09B 9/00

(52) U.S. Cl. CPC G09B 9/00

(57) ABSTRACT

A training simulation apparatus, for training a user in an electrode coating process performed by a coater including a plurality of manifolds, may include at least one processor; a memory configured to store at least one instruction executed by the at least one processor; and a user interface configured to receive conditions and condition adjustment values of one or more adjustment parameters for determining the operation of a virtual model device from a user, transmit the conditions and condition adjustment values of one or more adjustment parameters to the at least one processor, and output results of the execution of the at least one instruction by visualizing the results.

### CROSS-REFERENCE TO RELATED APPLICATIONS

The present application claims priority from Korean Patent Application No. 10-2024-0143551, filed October 21, 2024, the disclosure of which is hereby incorporated herein by reference.

### TECHNICAL FIELD

The present invention relates to a training simulation apparatus and a user training method using the simulation apparatus, and more particularly, to a training simulation apparatus and a user training method using the simulation apparatus for training an electrode coating process performed by a coater including a plurality of manifolds.

### BACKGROUND ART

Secondary batteries, capable of recharging and reuse, may be used as an energy source for small devices such as mobile phones, tablet PCs and vacuum cleaners, and also used as an energy source for medium and large devices such as personal mobility, automobiles and an energy storage system (ESS). Secondary batteries may be used in the form of an assembly such as a battery module in which a plurality of battery cells is connected in series and parallel or a battery pack in which battery modules are connected in series and parallel according to system requirements.

Recently, the growth of the electric vehicle and energy storage system markets has led to a rapid increase in demand for the development and production of secondary batteries. To meet this growing demand, the number of secondary battery production plants has also increased. However, there is a significant shortage of skilled workers to operate these secondary battery production plants.

Furthermore, since training and education for new workers was traditionally conducted by observing and learning from experienced workers, the busy secondary battery production schedule has made it difficult to provide long-term training and education for new workers. In addition, the retirement of workers has made it difficult to secure a sufficient number of skilled workers. Moreover, even if workers are trained on general factory operation methods, it is difficult to ensure they are able to respond promptly to various types of defects that may occur during operation.

To address these issues, a method of using simulators are utilized to train workers on how to operate secondary battery production equipment and how to respond to abnormalities, before deploying secondary battery production workers to the operation. However, as battery types and specifications change, the secondary battery production process also needs to adapt accordingly. Consequently, simulators of the secondary battery production process also need to adapt accordingly.

### DETAILED DESCRIPTION OF THE INVENTION

### [Technical Problem]

To obviate one or more problems of the related art, embodiments of the present disclosure provide a training simulation apparatus for training an electrode coating process performed by a coater including a plurality of manifolds.

To obviate one or more problems of the related art, embodiments of the present disclosure also provide a user training method utilizing the training simulation apparatus (simulator).

### [Technical Solution]

In order to achieve the objective of the present disclosure, a training simulation apparatus, for training a user in an electrode coating process performed by a coater including a plurality of manifolds, may include at least one processor; a memory configured to store at least one instruction executed by the at least one processor; and a user interface configured to receive conditions and condition adjustment values of one or more adjustment parameters for determining the operation of a virtual model device from a user, transmit the conditions and condition adjustment values of one or more adjustment parameters to the at least one processor, and output results of the execution of the at least one instruction by visualizing the results.

The at least one instruction may include an instruction to identify an opening ratio adjustment value of one or more manifolds included in the condition adjustment values; an instruction to calculate a loading amount of coating material for each manifold that varies according to the opening ratio adjustment value of the one or more manifolds; and an instruction to transmit the calculated loading amount of coating material for each manifold to the user interface.

The instruction to calculate the loading amount of coating material for each manifold may include an instruction to calculate the loading amount of coating material for each manifold based on the opening ratio adjustment values of the one or more manifolds and the coating material loading amounts of the plurality of manifolds.

Here, the loading amount of coating material for each manifold with an adjusted opening ratio may be calculated through dividing a value, obtained by multiplying the total coating material loading amount of the plurality of manifolds with the adjusted opening ratio of the corresponding manifold, by the sum of the opening ratios of each manifold.

Furthermore, the loading amount of coating material for each manifold with an unadjusted opening ratio may be calculated through dividing a value, obtained by multiplying the total coating material loading amount of the plurality of manifolds with an initial opening ratio of the corresponding manifold, by the sum of the opening ratios of each manifold.

Meanwhile, the user interface may include a condition setting device configured to set conditions for one or more adjustment parameters for determining the operation of a virtual model device based on user input; a simulator operation device configured to operate and display the virtual model device based on the adjustment parameters; and a quality verification device configured to display quality information related to the quality of a result produced by the virtual model device.

Her, each manifold may include an opening ratio controller that controls an amount of coating material flowing into the corresponding manifold.

In addition, the coating material may include an electrode active material slurry.

According to another embodiment of the present disclosure, a user training method, using a training simulator configured to train a user in an electrode coating process performed by a coater including a plurality of manifolds, may include receiving conditions and condition adjustment values of one or more adjustment parameters for determining the operation of a virtual model device from the user; identifying an opening ratio adjustment value of one or more manifolds included in the condition adjustment values; calculating a loading amount of coating material for each manifold that varies according to the opening ratio adjustment value of one or more manifolds; and displaying the calculated loading amount of coating material for each manifold.

The calculating of the loading amount of coating material for each manifold may include calculating the loading amount of coating material for each manifold based on the opening ratio adjustment values of the one or more manifolds and the coating material loading amounts of the plurality of manifolds.

The loading amount of coating material for each manifold with an adjusted opening ratio may be calculated through dividing a value, obtained by multiplying the total coating material loading amount of the plurality of manifolds with the adjusted opening ratio of the corresponding manifold, by the sum of the opening ratios of each manifold.

The loading amount of coating material for each manifold with an unadjusted opening ratio may be calculated through dividing a value, obtained by multiplying the total coating material loading amount of the plurality of manifolds with an initial opening ratio of the corresponding manifold, by the sum of the opening ratios of each manifold.

Each manifold may include an opening ratio controller that controls an amount of coating material flowing into the corresponding manifold.

The coating material may include electrode active material slurry.

### [Effects of Invention]

According to the above-described embodiments of the present invention, it is possible to provide new trainees involved in the secondary battery manufacturing process with virtual experience on the interaction of adjusting coating conditions and the quality optimization for various cases.

### BRIEF DESCRIPTION OF THE DRAWINGS

FIG. 1 is a schematic diagram of a battery manufacturing process.

FIG. 2 is a diagram illustrating an example of a user interface of a simulation apparatus according to embodiments of the present invention.

FIG. 3 illustrates an example of the structure of a manifold split coating die used for electrode coating.

FIG. 4 illustrates the loading amount change through adjustment of the opening ratio of each manifold of a manifold split coating die.

FIG. 5 is a block diagram of a simulation apparatus according to embodiments of the present invention.

FIG. 6 is an operational flowchart illustrating a user training method using a simulation apparatus according to embodiments of the present invention.

### DETAILED DESCRIPTION

The present invention may be modified in various forms and have various embodiments, and specific embodiments thereof are shown by way of example in the drawings and will be described in detail below. It should be understood, however, that there is no intent to limit the present invention to the specific embodiments, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term "and/or" includes combinations of a plurality of associated listed items or any of the plurality of associated listed items.

It will be understood that when an element is referred to as being "coupled" or "connected" to another element, it may be directly coupled or connected to the other element or an intervening element may be present. In contrast, when an element is referred to as being "directly coupled" or "directly connected" to another element, there is no intervening element present.

The terms used herein is for the purpose of describing specific embodiments only and are not intended to limit the present invention. As used herein, the singular forms "a", "an" and "the" are intended to include the plural forms as well, unless the context clearly indicates otherwise. It will be further understood that the terms "comprises", "comprising", "includes", "including" and/or "having", when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Hereinafter, exemplary embodiments of the present invention will be described in detail with reference to the accompanying drawings.

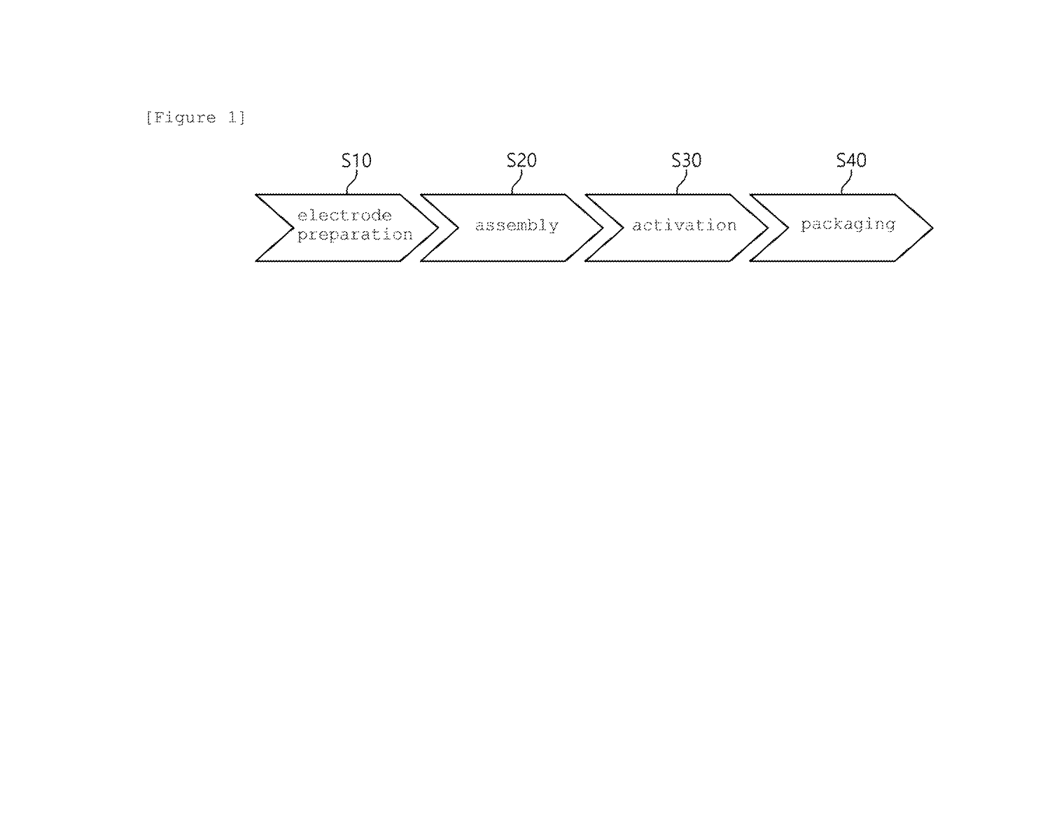

FIG. 1 is a schematic diagram of a battery manufacturing process.

The battery may be manufactured through an electrode preparation process (S10), an assembly process (S20), an activation process (S30), and a packaging process (S40). The battery completed through these processes may be shipped in the form of a battery pack (or battery module) including a plurality of battery cells connected in series. The battery pack may be connected to a load through a positive terminal and a negative terminal and may perform charge/discharge operations. Battery packs may be configured to be connected in series/parallel according to requirements of a system to which the battery is applied.

More specifically, the electrode preparation process (S10) may proceed in the following order: a 'mixing process' for mixing raw materials, a 'coating process' for applying mixed slurry to a foil and drying it, a 'roll pressing process' for compressing the electrode to reduce the thickness of the electrode, a 'slitting process' for cutting the electrode to a preset width, and a 'notching process' for creating a tab on the electrode.

In the present disclosure, a "mixing process" may be a process of mixing an active material, a binder, and other additives with a solvent to produce a slurry. For example, the user may determine or adjust the addition ratios of the active material, conductive material, additives, binder, etc., to produce a slurry of a specific quality.

A "coating process" may be a process of applying a slurry in a specific amount and shape onto a foil. For example, a user may determine or adjust the die of the coater device, the slurry temperature, etc., to perform a coating with specific quality of amount and shape.

A "rolling process" may be a process of pressing a coated electrode between two rotating upper and lower rolls to a specific thickness. For example, a user may determine or adjust the gap between the rolls, etc., to increase electrode density during the rolling process and maximize battery capacity. In addition, in the present disclosure, the "slitting process" may be a process of cutting the electrode into a predetermined width by passing the electrode between two rotating upper and lower knives. For example, a user may determine or adjust various adjustment parameters to maintain a predetermined electrode width.

A "notching and drying process" may be a process of removing moisture after stamping the electrode into a predetermined quality shape. For example, a user may determine or adjust cutting height, length, etc. to stamp the electrode into a predetermined shape. Additionally, in the present disclosure, a "lamination process" may be a process of sealing and cutting the electrode and separator. For example, a user may determine or adjust values corresponding to the x-axis, values corresponding to the y-axis, etc. to perform a predetermined cutting quality.

Meanwhile, the assembly process (S20) is a process of assembling the positive and negative plates manufactured through the electrode preparation process together with a separator to make a finished cell. The manufacturing order of the assembly process may differ depending on the battery type (cylindrical, pouch, prismatic), and technologies applied by each manufacturer may also differ. In addition, the activation process (S30) activates the electrical energy and verifies its stability. The final packaging process (S40) modularizes and packages the manufactured battery cells.

As illustrated in FIG. 1, manufacturing secondary batteries requires numerous detailed processes, each demanding a high level of work quality. Furthermore, demand for secondary batteries is increasing, leading to a growing need for skilled workers.

Consequently, workers to be involved in secondary battery production are trained using a simulator to learn how to operate secondary battery production equipment and how to respond to defects before the workers begin battery manufacturing work.

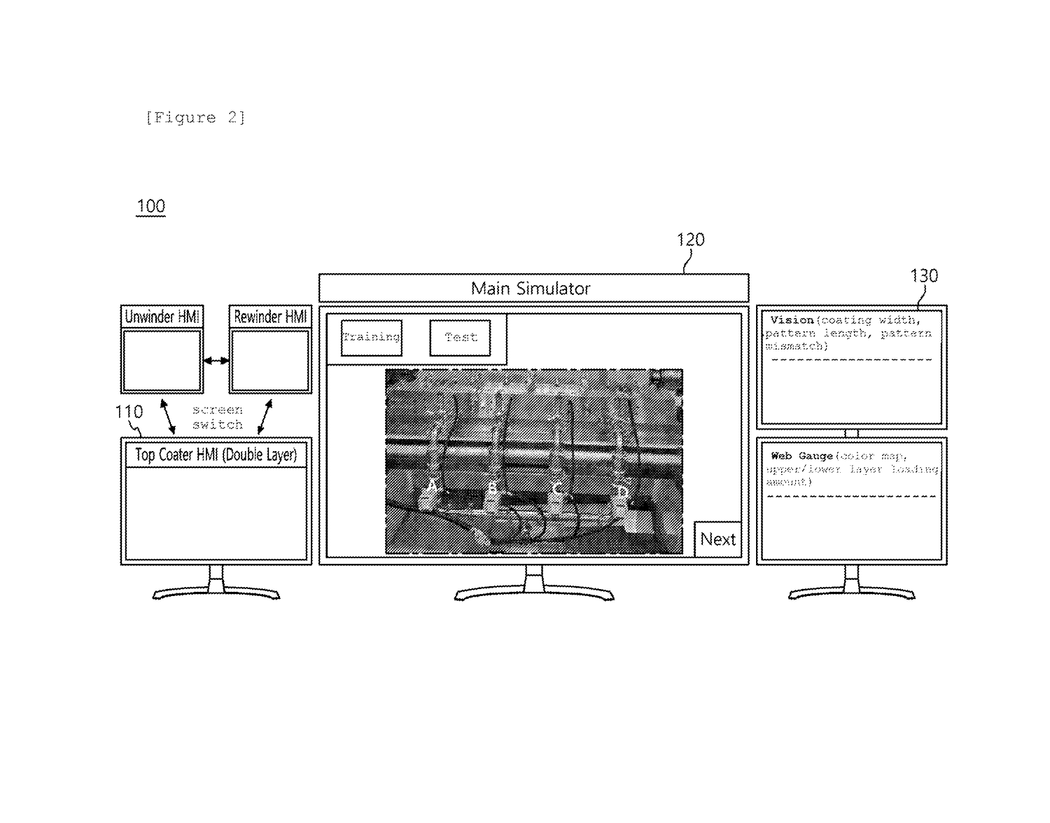

FIG. 2 is a diagram illustrating an example of a user interface of a simulation apparatus according to embodiments of the present invention.

Referring to FIG. 2, the simulation apparatus 100 may serve as an apparatus for training secondary battery production workers (referred to herein as "users") and provides various user interfaces to the user. The user interface according to embodiments of the present invention may be implemented by including a condition setting device 110, a simulator operation device 120, and a quality verification device 130. Accordingly, the user may operate the condition setting device 110, simulator operation device 120, and quality verification device 130 provided by the simulation apparatus, which virtually (e.g., 2D, 3D, etc.) implements actual secondary battery production equipment, thereby learning how to use secondary battery production equipment (e.g., a coater) or training in response methods when the quality of a manufactured product deteriorates.

According to one embodiment, the condition setting device 110 may be implemented using a Human-Machine Interface (HMI) and is a device implemented to allow a user to adjust one or more adjustment parameters for determining the operation of a virtual model device displayed on the simulator operation device 120. The user may execute, change, and/or correct the operation of the 2D/3D virtual model device by changing at least some conditions of the adjustment parameters. In other words, the operation of the virtual model device may be adaptively changed or corrected based on changes in the adjustment parameters input by the user. While the condition setting device 110 of FIG. 1 displays a coater HMI, the screen can be switched to an unwinder HMI, a rewinder HMI, etc.

The simulator operation device 120 may include a virtual model device associated with the production of secondary batteries. Here, the virtual model device may include 2D/3D virtual model devices associated with secondary battery production equipment, such as a mixer, coater, slitter, roll presser, lamination device, and lamination & stack (L&S) device.

According to embodiments, a user may manipulate the virtual model device or change its configuration through input to the virtual model device represented by the simulator operation device 120. Here the user may check or zoom in/out any area of the virtual model device through view switching, etc., and may manipulate the virtual model device or change its configuration through touch input, etc.

Meanwhile, the simulator operation device 120 of the simulation apparatus may operate through processes such as an HMI guide stage, a condition adjustment preparation stage, a condition adjustment execution stage, a case training stage, and a test stage. Through these stages, a user can be trained with operating secondary battery production equipment.

The HMI guide stage may be a stage where users learn about the types of adjustment parameters included in the condition setting device and how to manipulate them. The condition adjustment preparation stage may be a stage where users learn how to set initial values for the condition setting device, simulator operation device, and quality check device before operating the secondary battery production equipment.

The condition adjustment execution stage may be a stage where users learn how to identify and address defects that occur during the operation of the secondary battery production equipment. For example, in the case of a coater, surface defects, loading amount defects, and uncoated area width defects may occur. When a defect occurs, the type of adjustment parameter that must be manipulated to resolve the defect, its value, and the settings of the 3D model device may be displayed or output. The user may process the defect based on this displayed information and train themselves on how to resolve the defect.

The case training stage may be a stage where the user repeatedly processes or resolves multiple defect scenarios associated with the secondary battery production equipment, individually or in combination, to master the defect resolution method. The simulator operation device 120 of FIG. 2 displays one of the training stages. Furthermore, the testing phase may be a step to evaluate the user's operational capabilities by testing the user's process for resolving a defect scenario.

The quality verification device 130 may display quality information related to the quality of an object (output result) generated by the virtual model device. Here, the quality information may be generated by performing calculations on quality parameters, etc., based on predetermined criteria and/or algorithms. In other words, a user may check the quality information generated in response to changing adjustment parameters or manipulating the virtual model device through the quality verification device 130. The screen of the quality verification device 130 in FIG. 2 displays vision information related to the quality of the resultant product during the coating process (e.g., coating width, pattern length, pattern mismatch) and web gauge information (color map, upper/lower layer loading amount).

In particular, embodiments of the present invention provide a training simulation apparatus for coating process training using a coating die with a manifold split structure, and a user training method using the same.

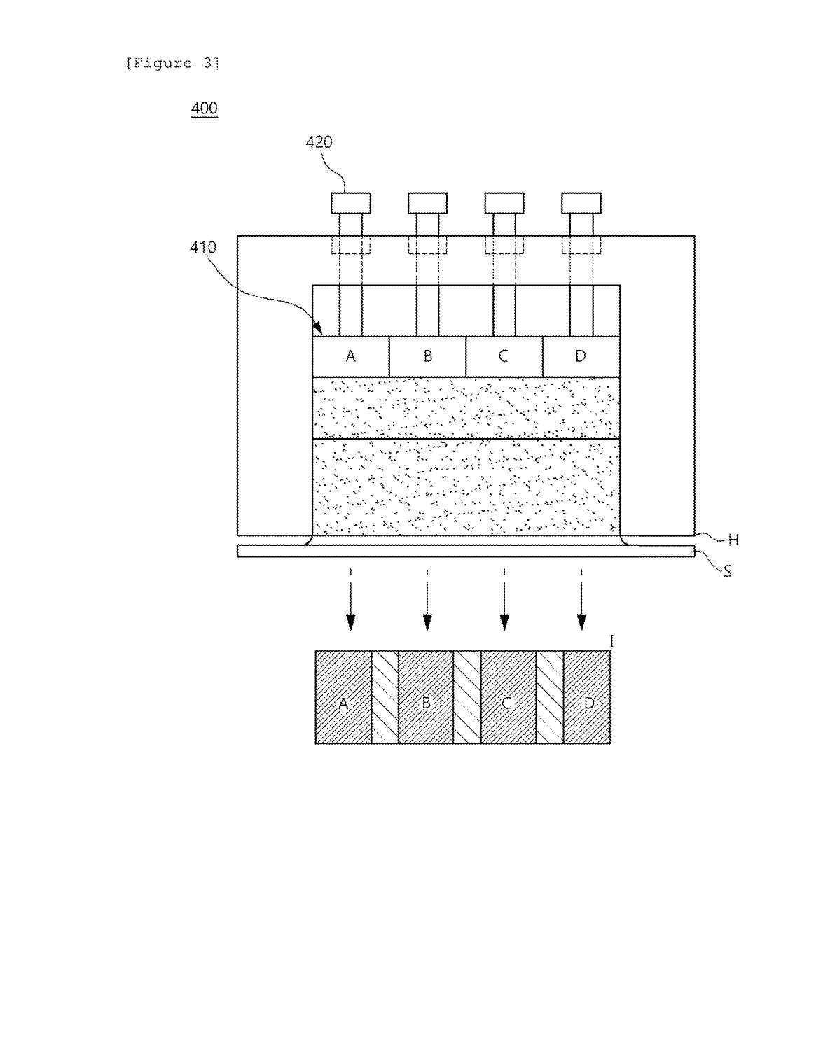

FIG. 3 illustrates an example of the structure of a manifold split coating die used for electrode coating.

The coater, which is equipment utilized in a coating process contemplated in the present disclosure, may refer to a device for coating a slurry prepared through a mixing process onto a current collector (e.g., foil). For example, the coater may include a coating die through which electrode active material slurry is discharged, a coating roller, etc. In the coating process performed by such a coater, it is important to perform the coating with a consistent thickness, width, and pattern to produce a quality product. Here, the thickness, width, and pattern of the coating may be varied by setting values and/or condition values such as rounds per minute of pump (pump RPM), die gap, die bending, slurry temperature, shim offset, and edge position control (EPC).

FIG. 3 illustrates an example of a coating die 400 with a manifold split structure that performs the coating process. The structure of the manifold split coating die according to the present disclosure is not limited to the example of FIG. 3. A coating die structure in which a coating material, i.e., an active material slurry, is supplied to each manifold using a supply pump connected to a plurality of manifolds, as illustrated on the simulator operation device 120 of FIG. 1, may also be included within the scope of the coating die considered in the present invention.

A plurality of manifolds 410 may be arranged at predetermined intervals along the width direction of the substrate (S) perpendicular to the transport direction (or, opposite to the transport direction) of the substrate (S) within the body. An individual opening ratio controller 420 may be installed on each manifold 410. Meanwhile, the opening ratio controller 420 may be implemented in the form of a control valve, as illustrated in FIG. 1.

Each manifold 410 constituting the coating die 400 may be individually driven according to the state of the slurry (I) to be coated on the substrate, and the discharge amount of the electrode active material slurry (I) discharged from the discharge port (H) may be controlled by changing the discharge amount controlled by the opening ratio controller 420 at the position where it is placed.

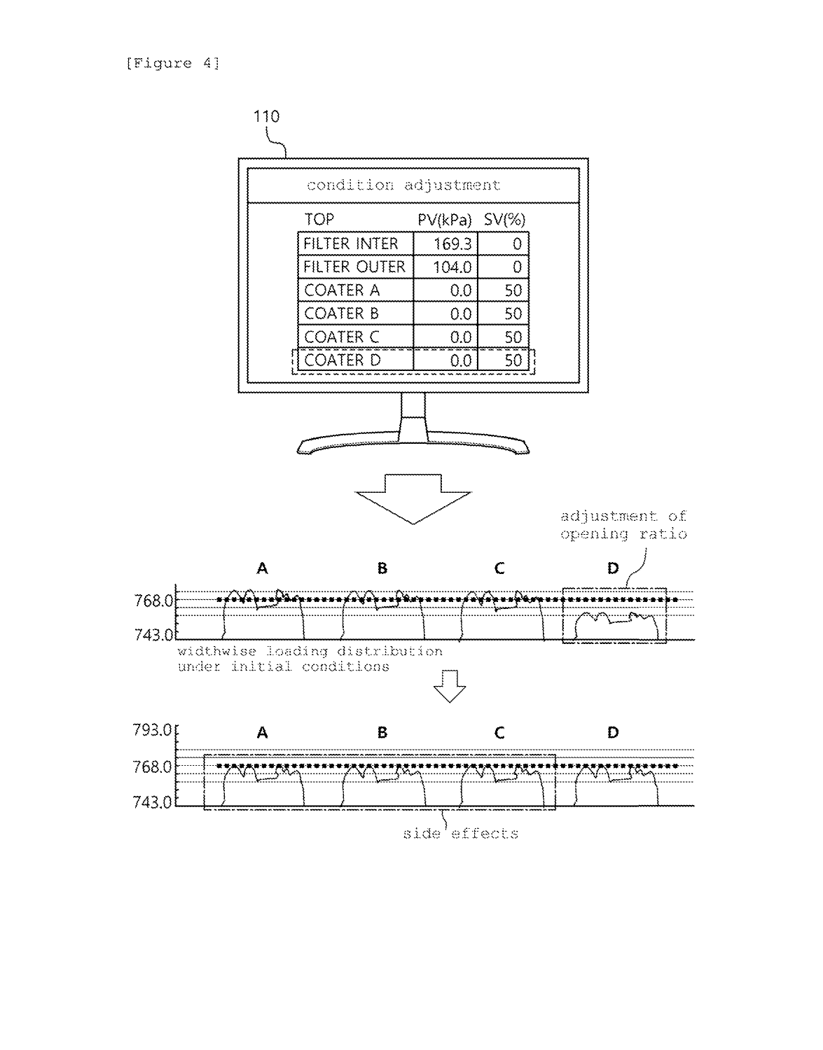

FIG. 4 illustrates the loading amount change through adjustment of the opening ratio of each manifold of a manifold split coating die.

As previously discussed, the amount of electrode active material slurry discharged from a manifold may be controlled by adjusting the opening ratio of each manifold of the manifold split die. The opening ratio (degree of opening) of each manifold may be adjusted via an opening ratio controller. While fully closed may be expressed as "0," fully open may be expressed as "100." However, considering practical limitations, the opening ratio is typically set within the range of (50±10%).

Referring to the example of FIG. 4, the conditions related to the opening ratio of the manifold may be adjusted via a coater HMI of the condition adjustment device 110. In this embodiment, a coating die with four manifolds is used, with each manifold represented as Coater A, Coater B, Coater C, or Coater D. The initial opening ratio of each manifold is set to "50(%)." Here, the RPM of supply pumps connected to the plurality of manifolds is assumed to be fixed. In other words, the total amount of slurry supplied to the coating die from the outside is assumed to remain constant.

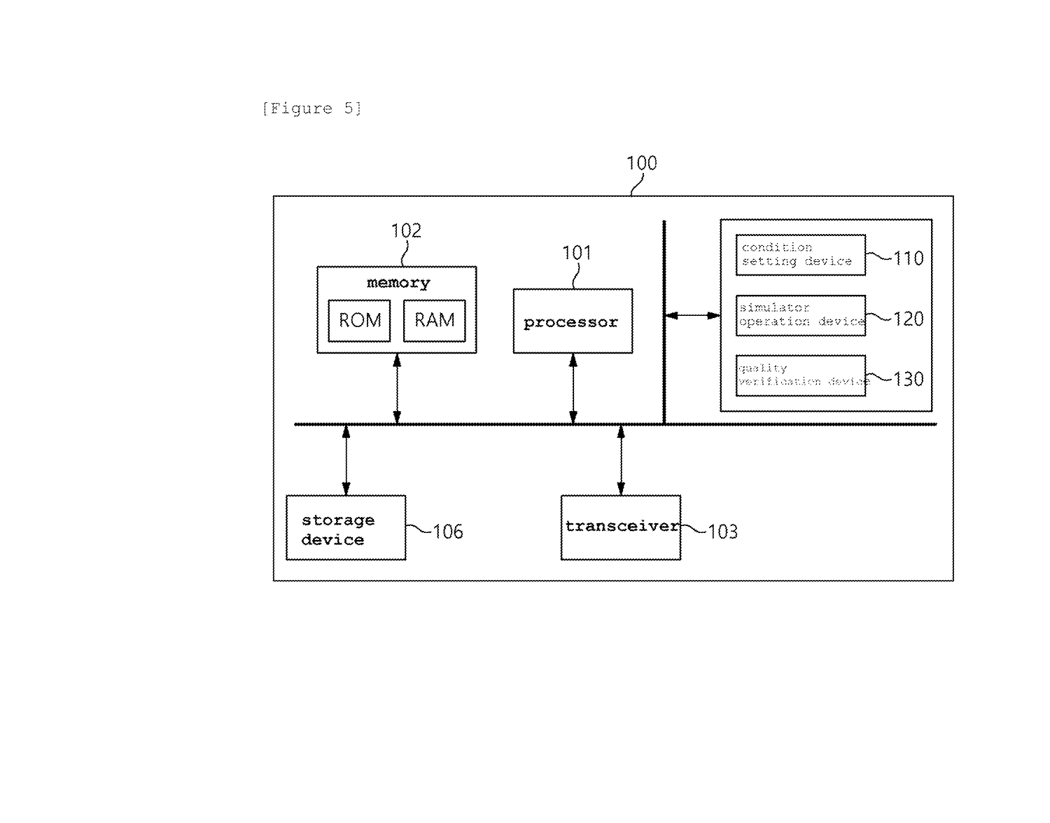

With the opening ratios of each manifold set to the same value (i.e., under initial conditions), the widthwise loading distribution for each manifold is shown in the upper graph among two graphs in FIG. 5. Even though each manifold is set to the same opening ratio, differences in the actual loading amount on the substrate is observed. If a user determines that the loading of manifold D is lower than that of the other manifolds and adjusts the opening ratio of manifold D upward, the loading of manifold D will increase. However, increasing the opening ratio of manifold D while the total amount of coating material supplied to the coating die is fixed may have the unintended consequence of reducing the loading of manifolds A, B, and C.

For example, assume that the opening ratios of each manifold are all set to "50(%)" and the total loading amount of the manifolds (A, B, C, D) is S. When the opening ratio of manifold D is increased by k% while the total loading amount S is fixed, the loading amount of manifold D may be calculated as "SⅩ(50+k)/(50+50+50+(50+k))". Meanwhile, the loading amounts of manifolds A, B, and C may be calculated as "SⅩ(50)/(50+50+50+(50+k))". In other words, the loading amount of manifold D increased, while, as a side effect, the loading amounts of manifolds A, B, and C decreased.

In other words, since adjusting the opening ratio of a specific manifold may have side effects on the loading amounts of other manifolds, the present disclosure is proposed to provide a condition adjustment experience similar to reality by additionally applying this side effect to the training process using a simulator.

FIG. 5 is a block diagram of a simulation apparatus according to embodiments of the present invention.

The simulation apparatus 100 according to embodiments of the present invention may be a training simulation apparatus for training an electrode coating process performed by a coater including a plurality of manifolds. The simulation apparatus may include at least one processor 101, a memory 102 storing at least one instruction executed by the processor, and a transceiver 103 connected to a network for communication.

At least one processor 101 of the simulation apparatus 100 may be connected to a condition setting device 110, a simulator operation device 120, and a quality verification device 130 to exchange data or information related to a virtual model device. Meanwhile, in FIG. 3, the simulation apparatus 100 is illustrated as including a condition setting device 110, a simulator operation device 120, and a quality verification device 130. However, the condition setting device 110, the simulator operation device 120, and the quality verification device 130 may each be implemented as separate hardware (e.g., a user interface) that works in conjunction with the simulation apparatus 100.

The processor 101 may execute, modify, or correct the operation of the 3D virtual model device displayed on the simulator operation device 120 according to user operations. According to one embodiment, the processor 101 may acquire or receive user action information and user condition information using information input from a user (secondary battery manufacturing worker). The processor 101 may also determine or modify the operation of the virtual model device using the acquired or received user action information and user condition information.

The user action information is information generated based on user input, such as touching at least a portion of a virtual model device included in the simulator operation device 120, which may include information regarding changes in the virtual model device's settings based on the user input. For example, if the virtual model device is a coater for secondary battery production, a user may select and release a fixing bolt in the die area of the coater using a touch input or the like through the simulator operation device 120 and change the shim offset. In this case, the user action information may be generated based on the changed shim offset.

The user condition information is information generated based on user input that changes the conditions or values of at least some of the adjustment parameters included in the condition setting device 110, which may include information regarding changes in the condition values used to determine the operation of the virtual model device based on the user input. For example, if the virtual model device is a coater for secondary battery production, the user may change the openness of a specific manifold among the coaters to a specific value through the condition setting device 110. Here, the user condition information may be generated based on the changed opening ratio value of the manifold.

If the operation of the virtual model device is performed based on user condition information or user action information, the processor 101 can determine or generate quality information related to the quality of the material produced by the operation of the virtual model device. In other words, when the virtual model device is in operation (when animations, videos, etc. are executed by the virtual model device), the quality information can be determined or generated differently depending on the setting values, condition values, etc. of the virtual model device. In other words, the user can change or adjust the quality of an object (any result or output) produced by the virtual model device by changing adjustment parameters or setting at least a portion of the virtual model device using touch input, etc.

The processor 101 may determine or extract one or more quality parameters for determining the quality of an object produced by the virtual model device, and may calculate values corresponding to each of the one or more quality parameters determined based on the operation of the virtual model device while the virtual model device is operating. Here, the values corresponding to the quality parameters may be calculated using any predetermined algorithm. Furthermore, the processor 101 may generate quality information associated with the quality of the object produced by the virtual model device based on the values corresponding to each of the one or more calculated quality parameters. For example, if the virtual model device is a coater for secondary battery production, when a user adjusts the opening ratio of a specific manifold, the loading amount may be determined as a quality parameter, and a value corresponding to the loading amount may be calculated. In this case, the processor 101 may generate or output quality information including the calculated loading amount.

Meanwhile, abnormality scenarios associated with a malfunction of the virtual model device may occur during or before the operation of the virtual model device. When an abnormality scenario occurs, at least some of the virtual model device's setup values, condition values, and corresponding quality information may be changed to an abnormal range based on the generated abnormality scenario.

Furthermore, the processor 101 may determine whether one or more abnormality scenarios have been resolved using the corrected quality information. If one or more abnormality scenarios are determined to have been resolved, the processor 101 may calculate the progress time, loss values, etc. of one or more abnormality scenarios while the one or more abnormality scenarios are in progress. For example, the loss values may include coating loss values, material loss values, etc., and may be calculated through a predetermined algorithm based on the user's response time, user input values, etc. Additionally, the processor 101 may determine whether the user has passed the simulation training based on operation capability information for each abnormality scenario if the user has resolved all predetermined types of abnormality scenarios.

In summary, according to embodiments of the present invention, a training simulation apparatus for training an electrode coating process performed by a coater including a plurality of manifolds may include at least one processor; a memory configured to store at least one instruction executed by the at least one processor; and a user interface configured to receive conditions and condition adjustment values of one or more adjustment parameters for determining the operation of a virtual model device from a user, transmit the conditions and condition adjustment values of one or more adjustment parameters to the at least one processor, and output results of the execution of the at least one instruction by visualizing the results.

The at least one instruction may include an instruction to identify an opening ratio adjustment value of one or more manifolds included in the condition adjustment values; an instruction to calculate a loading amount of coating material for each manifold that varies according to the opening ratio adjustment value of the one or more manifolds; and an instruction to transmit the calculated loading amount of coating material for each manifold to the user interface.

The instruction to calculate the loading amount of coating material for each manifold may include an instruction to calculate the loading amount of coating material for each manifold based on the opening ratio adjustment values of the one or more manifolds and the coating material loading amounts of the plurality of manifolds.

Here, the loading amount of coating material for each manifold with an adjusted opening ratio may be calculated through dividing a value, obtained by multiplying the total coating material loading amount of the plurality of manifolds with the adjusted opening ratio of the corresponding manifold, by the sum of the opening ratios of each manifold.

Furthermore, the loading amount of coating material for each manifold with an unadjusted opening ratio may be calculated through dividing a value, obtained by multiplying the total coating material loading amount of the plurality of manifolds with an initial opening ratio of the corresponding manifold, by the sum of the opening ratios of each manifold.

Meanwhile, the user interface may include a condition setting device configured to set conditions for one or more adjustment parameters for determining the operation of a virtual model device based on user input; a simulator operation device configured to operate and display the virtual model device based on the adjustment parameters; and a quality verification device configured to display quality information related to the quality of a result produced by the virtual model device.

Here, each manifold may include an opening ratio controller that controls an amount of coating material flowing into the corresponding manifold. In addition, the coating material may include an electrode active material slurry.

Meanwhile, the simulation apparatus 100 according to embodiments of the present invention may further include a storage device 106, etc. Here, the processor 101 may refer to a central processing unit (CPU), a graphics processing unit (GPU), or a dedicated processor on which methods according to embodiments of the present invention are performed. The memory (or storage device) may be configured as at least one of a volatile storage medium and a nonvolatile storage medium. For example, the memory may include at least one of read only memory (ROM) and random access memory (RAM).

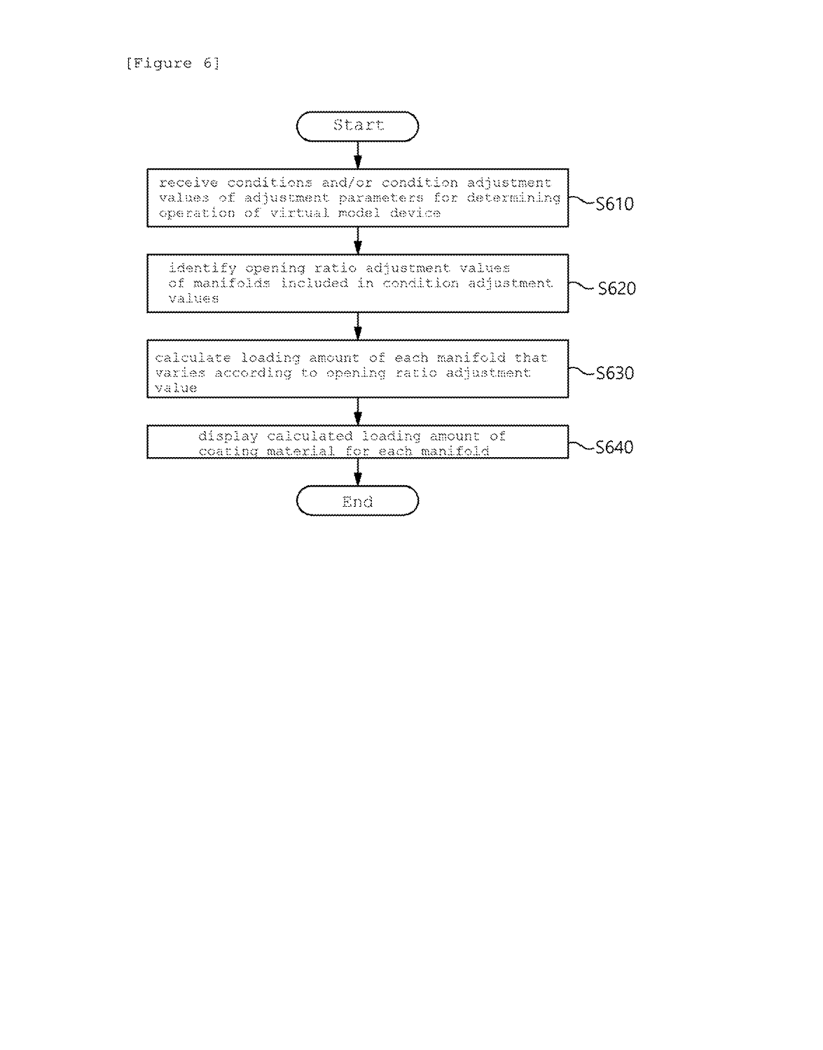

FIG. 6 is an operational flowchart illustrating a user training method using a simulation apparatus according to embodiments of the present invention.

The simulation method according to embodiments of the present invention is a user training method using a training simulator that trains an electrode coating process performed by a coater including a plurality of manifolds.

Referring to FIG. 6, the training simulation apparatus may receive the conditions of adjustment parameters and condition adjustment values of adjustment parameters for determining the operation of the virtual model device, from a user (S610). Here, the user may input the conditions and/or condition adjustment values of adjustment parameters for determining the operation of the virtual model device through a condition setting device (e.g., coater HMI).

The training simulation apparatus may identify the opening ratio adjustment values of one or more manifolds included in the received condition adjustment values (S620) and calculate the loading amount of each manifold that varies according to the opening ratio adjustment values of one or more manifolds (S630). More specifically, the loading amount of coating material for each manifold may be calculated based on the opening ratio adjustment values of one or more manifolds and the loading amounts of coating material of a plurality of manifolds.

Here, the coating material loading amount of a manifold with an adjusted opening ratio can be calculated by multiplying the total coating material loading amount of the plurality of manifolds by the adjusted opening ratio of the corresponding manifold, and dividing the product by the sum of the opening ratios of each manifold.

Furthermore, the coating material loading amount of a manifold with an unadjusted opening ratio can be calculated by multiplying the total coating material loading amount of the plurality of manifolds by the initial opening ratio of the corresponding manifold, and dividing the product by the sum of the opening ratios of each manifold.

Thereafter, the training simulation apparatus may transmit the calculated loading amount of coating material for each manifold to the quality verification device of the user interface, and control the quality check device to display the loading amount of coating material (S640).

Here, each manifold may include an opening ratio controller that adjusts the amount of coating material flowing into the corresponding manifold. Furthermore, the coating material may include an electrode active material slurry.

According to the above-described embodiments of the present invention, it is possible to provide new trainees involved in the secondary battery manufacturing process with virtual experience on the interaction of adjusting coating conditions and quality optimization for various cases.

The operations of the method according to the embodiments of the present invention may be implemented as a computer-readable program or code on a computer-readable recording medium. The computer-readable recording medium includes all types of recording devices in which data readable by a computer system is stored. In addition, the computer-readable recording medium may be distributed in a network-connected computer system to store and execute computer-readable programs or codes in a distributed manner.

Although some aspects of the invention have been described in the context of the apparatus, it may also represent a description according to a corresponding method, wherein a block or apparatus corresponds to a method step or feature of a method step. Similarly, aspects described in the context of a method may also represent a feature of a corresponding block or item or a corresponding apparatus. Some or all of the method steps may be performed by (or using) a hardware device, such as, for example, a microprocessor, a programmable computer, or an electronic circuit. In some embodiments, one or more of the most important method steps may be performed by such an apparatus.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A training simulation apparatus for training a user in an electrode coating process performed by a coater including a plurality of manifolds, the apparatus comprising:
at least one processor;
a memory configured to store at least one instruction executed by the at least one processor; and
a user interface configured to receive conditions and condition adjustment values of one or more adjustment parameters for determining the operation of a virtual model device from the user, transmit the conditions and condition adjustment values of one or more adjustment parameters to the at least one processor, and output result of the execution of the at least one instruction by visualizing the results,
wherein the at least one instruction includes:
an instruction to identify an opening ratio adjustment value of one or more manifolds included in the condition adjustment values;
an instruction to calculate a loading amount of coating material for each manifold that varies according to the opening ratio adjustment value of the one or more manifolds; and
an instruction to transmit the calculated loading amount of coating material for each manifold to the user interface.

2. The apparatus of claim 1, wherein the instruction to calculate the loading amount of coating material for each manifold includes:
an instruction to calculate the loading amount of coating material for each manifold based on the opening ratio adjustment values of the one or more manifolds and the coating material loading amounts of the plurality of manifolds.

3. The apparatus of claim 2, wherein the loading amount of coating material for each manifold with an adjusted opening ratio is calculated through dividing a value, obtained by multiplying the total coating material loading amount of the plurality of manifolds with the adjusted opening ratio of the corresponding manifold, by the sum of the opening ratios of each manifold.

4. The apparatus of claim 2, wherein the loading amount of coating material for each manifold with an unadjusted opening ratio is calculated through dividing a value, obtained by multiplying the total coating material loading amount of the plurality of manifolds with an initial opening ratio of the corresponding manifold, by the sum of the opening ratios of each manifold.

5. The apparatus of claim 1, wherein the user interface includes:
a condition setting device configured to set conditions for one or more adjustment parameters for determining the operation of a virtual model device based on user input;
a simulator operation device configured to operate and display the virtual model device based on the adjustment parameters; and
a quality verification device configured to display quality information related to the quality of a result produced by the virtual model device.

6. The apparatus of claim 1, wherein each manifold includes an opening ratio controller that controls an amount of coating material flowing into the corresponding manifold.

7. The apparatus of claim 1, wherein the coating material includes electrode active material slurry.

8. A user training method by a training simulator configured to train a user in an electrode coating process performed by a coater including a plurality of manifolds, the method comprising:
receiving conditions and condition adjustment values of one or more adjustment parameters for determining the operation of a virtual model device from the user;
identifying an opening ratio adjustment value of one or more manifolds included in the condition adjustment values;
calculating a loading amount of coating material for each manifold that varies according to the opening ratio adjustment value of one or more manifolds; and
displaying the calculated loading amount of coating material for each manifold.

9. The method of claim 8, wherein the calculating of the loading amount of coating material for each manifold includes:
calculating the loading amount of coating material for each manifold based on the opening ratio adjustment values of the one or more manifolds and the coating material loading amounts of the plurality of manifolds.

10. The method of claim 9, wherein the loading amount of coating material for each manifold with an adjusted opening ratio is calculated through dividing a value, obtained by multiplying the total coating material loading amount of the plurality of manifolds with the adjusted opening ratio of the corresponding manifold, by the sum of the opening ratios of each manifold.

11. The method of claim 9, wherein the loading amount of coating material for each manifold with an unadjusted opening ratio is calculated through dividing a value, obtained by multiplying the total coating material loading amount of the plurality of manifolds with an initial opening ratio of the corresponding manifold, by the sum of the opening ratios of each manifold.

12. The method of claim 8, wherein each manifold includes an opening ratio controller that controls an amount of coating material flowing into the corresponding manifold.

13. The method of claim 8, wherein the coating material includes electrode active material slurry.
